(19) United States
(12) Patent Application Publication
(10) Pub. No.: US 2026/0360978 A1
(43) Pub. Date: Nov. 12, 2026

(54) Antenna apparatus with interconnected parasitic director elements and high impedance circuit for integrated proximity sensing

(71) Applicant: MEDIATEK INC., Hsinchu City (TW)

(72) Inventors: Wei-Hsuan Chang, Hsinchu City (TW); Shih-Wei Hsieh, Hsinchu City (TW); Chih-Wei Lee, Hsinchu City (TW); Shyh-Tirng Fang, Hsinchu City (TW)

(73) Assignee: MEDIATEK INC., Hsinchu City (TW)

(21) Appl. No.: 19/658,691

(22) Filed: Apr. 26, 2026

Related U.S. Application Data
(60) Provisional application No. 63/801,906, filed on May 8, 2025.

(51) Int. Cl. H01Q 5/378; H01Q 1/22; H01Q 9/04

(52) U.S. Cl. CPC H01Q 5/378; H01Q 1/22; H01Q 9/0407

(57) ABSTRACT

An antenna apparatus includes a plurality of antenna elements, a plurality of parasitic elements, an interconnection conductor, and a proximity sensor port. Each antenna element radiates a radio frequency signal at a communication frequency band. Each parasitic element is disposed adjacent to and electromagnetically coupled to a respective antenna element, and is physically separated from the respective antenna element. The interconnection conductor couples the plurality of parasitic elements to form a contiguous conductive structure. The interconnection conductor includes at least one high impedance circuit. The high impedance circuit is implemented as a lumped circuit or a transmission line segment that presents a high impedance at the communication frequency band. The proximity sensor port is coupled to the contiguous conductive structure. A single proximity sensor port serves the plurality of parasitic elements for capacitive proximity sensing at a sensing frequency band lower than the communication frequency band.

### CROSS REFERENCE TO RELATED APPLICATIONS

This application claims the benefit of U.S. Provisional Application No. 63/801,906, filed on May 8, 2025. The content of the application is incorporated herein by reference.

### BACKGROUND

Wireless communication systems increasingly use multiple-input multiple-output (MIMO) antenna arrays that operate at high radio frequencies. These arrays typically need proximity detection to keep radio emissions within regulatory limits when a user is nearby. Previous proximity detection designs take one of two forms. In a first form, a dedicated sensor pad is placed separately from the antenna array, which requires additional board area for the dedicated sensor pad. In a second form, each antenna element serves as both a radiator and a sensor pad, with a diplexer separating the radio frequency signal from the proximity sensing signal for each antenna element. This second form requires a dedicated proximity sensor port for each antenna element. In addition, each antenna element serves two functions, which creates competing design requirements. A design change that improves antenna performance may not improve proximity sensing performance, and a design change that improves proximity sensing performance may not improve antenna performance. As a result, previous approaches to combining MIMO operation with proximity detection involve a trade-off between hardware cost and design flexibility.

### SUMMARY

According to some embodiments, an antenna apparatus comprises a plurality of antenna elements, a plurality of parasitic elements, an interconnection conductor, and a proximity sensor port. Each antenna element of the plurality of antenna elements is configured to radiate a radio frequency signal at a communication frequency band. Each parasitic element of the plurality of parasitic elements is disposed adjacent to a respective antenna element of the plurality of antenna elements and electromagnetically coupled thereto. Each parasitic element is physically separated from the respective antenna element. The interconnection conductor is coupled to the plurality of parasitic elements to form a contiguous conductive structure. The interconnection conductor comprises at least one high impedance circuit. The at least one high impedance circuit comprises a lumped circuit or a transmission line segment configured to present a high impedance at the communication frequency band. The proximity sensor port is coupled to the contiguous conductive structure.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top plan view of an antenna apparatus according to an embodiment of the present disclosure.

FIG. 2 is an enlarged partial view of a portion of the antenna apparatus of FIG. 1.

FIG. 3 is a cross-sectional view of the antenna apparatus of FIG. 1, taken along section line 3-3′.

FIG. 4 is a circuit schematic illustrating a lumped circuit of the high impedance circuit of the antenna apparatus of FIG. 1.

FIG. 5 is a Smith chart illustrating an impedance locus of the high impedance circuit of FIG. 4.

FIG. 6 is a graph illustrating a return loss and an isolation of the antenna apparatus of FIG. 1 as a function of frequency.

FIG. 7 is a top plan view of an antenna apparatus according to another embodiment of the present disclosure.

FIG. 8 is a detail view illustrating transmission line segments of the high impedance circuit of the antenna apparatus of FIG. 7.

### DETAILED DESCRIPTION

The following description sets forth exemplary embodiments and does not limit the scope of the appended claims. Features described in connection with one embodiment may be combined with features of other embodiments. Reference throughout this specification to “one embodiment,” “an embodiment,” “certain embodiments,” or similar language means that a particular feature, structure, or characteristic described in connection with the embodiment may be included in at least one embodiment.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-understood circuit elements, fabrication processes, and signaling conventions have not been described in exhaustive detail so as not to obscure the embodiments.

The drawings are not necessarily drawn to scale. Relative dimensions, layer thicknesses, and spacings shown in the drawings may be exaggerated or reduced to facilitate illustration. Like reference numerals refer to like elements throughout the several views.

As used herein, the term “coupled” refers to any connection, coupling, link, or the like by which signals carried by one element are imparted to the coupled element. Coupled elements are not necessarily directly connected to one another and may be separated by intermediate components. As used herein, “electrically coupled” refers to coupling of an electrical kind by which electrical signals are transferred from one element to another through a conductive path, and encompasses both direct galvanic connection and connection through one or more intermediate conductive components. As used herein, “electrically connected” refers to a direct galvanic connection between two elements through a continuous conductive path without interruption by a non-conductive gap. As used herein, “galvanic connection” refers to a connection between two elements that provides a continuous conductive path capable of carrying direct current between the two elements, whether by direct contact between the two elements or through one or more intermediate conductive components. As used herein, “galvanic contact” refers to a direct physical contact between two conductive elements without an intervening non-conductive material, the direct physical contact itself providing a continuous conductive path capable of carrying direct current between the two elements. Two elements in galvanic contact are in galvanic connection, whereas two elements in galvanic connection are not necessarily in galvanic contact and may be connected through one or more intermediate conductive components.

As used herein, a component “configured to” perform a function refers to an existing physical structure arranged to perform the function. The structural features of the component enable the recited function without requiring further modification. As used herein, the term “comprising” or “comprises” is open-ended and does not exclude additional, unrecited elements. The terms “a” and “an” refer to one or more unless context indicates otherwise.

As used herein, the term “approximately” in connection with a numerical value refers to values within a tolerance range of the stated value. The tolerance range may be determined based on the precision of measurement or fabrication involved.

As used herein, the term “substantially” when modifying a quantity or condition refers to meeting the quantity or condition to a degree that achieves the intended technical effect of the embodiments, allowing for reasonable deviations attributable to manufacturing tolerance, measurement accuracy, and operational variation.

As used herein, “electromagnetically coupled” refers to non-contact energy transfer between two conductive elements through a gap therebetween, without direct galvanic connection. Electromagnetically coupled elements are physically separated and exchange radio frequency energy through the electromagnetic fields radiated and received across the gap.

As used herein, “physically separated” refers to an absence of direct galvanic contact between two elements. The gap therebetween provides direct-current isolation between the two elements, while permitting electromagnetic coupling at a radio frequency band.

As used herein, “high impedance” refers to an impedance magnitude presented by a high impedance circuit at a communication frequency band that is sufficient to substantially block radio frequency current from propagating through an interconnection conductor in which the high impedance circuit is disposed. The high impedance is characterized herein by reference to one or more of the following alternative measures, any one or any combination of which characterizes a circuit as presenting a high impedance at the communication frequency band.

As used herein, a “resistance component” of a complex impedance refers to a real part of the complex impedance, representing a dissipative portion of the complex impedance at which electrical energy is converted to heat or radiated outward. As used herein, a “reactance component” of a complex impedance refers to an imaginary part of the complex impedance, representing a non-dissipative portion of the complex impedance at which electrical energy is alternately stored and released, the reactance component being positive for an inductive reactance and negative for a capacitive reactance.

According to a first measure, the high impedance has a magnitude that is substantially greater than a reference characteristic impedance of a radio frequency port of an antenna element, where the impedance magnitude is computed from the complex impedance

Z=R+jX
in which R denotes the resistance component, X denotes the reactance component, and j denotes the imaginary unit satisfying j squared=−1, as the absolute value

|Z|=\sqrt{R²+X²}

In some embodiments, the reference characteristic impedance is approximately 50 ohms.

According to a second measure, the high impedance corresponds to an impedance located proximate to an open-circuit region of a Smith chart that is normalized to a reference characteristic impedance of approximately 50 ohms. The open-circuit point is located at the rightmost vertex of the Smith chart, where the normalized impedance approaches infinity. The open-circuit region, as used herein, refers to a region surrounding the open-circuit point. Within the open-circuit region, the impedance is dominated by the reactance component, either inductive or capacitive, with a relatively small resistance component.

According to a third measure, the high impedance is sufficient to maintain an isolation of less than approximately −15 decibels between each antenna element of an antenna array and a proximity sensor port across the communication frequency band, where the isolation is measured as the magnitude of a scattering parameter S21, the scattering parameter S21 denoting a transmission coefficient from the radio frequency port of each antenna element to the proximity sensor port.

The three measures above are alternative characterizations of the same physical condition, namely that the high impedance circuit presents a sufficiently large impedance at the communication frequency band to substantially block radio frequency current along the interconnection conductor. An embodiment satisfies the high impedance condition by satisfying any one of the three measures or any combination of the three measures. The high impedance condition is to be assessed at or near a center frequency of the communication frequency band of operation.

As used herein, “the center frequency of the communication frequency band” refers to a representative frequency within the communication frequency band, selected as a reference frequency for characterizing operation of the antenna apparatus s at the communication frequency band. In some embodiments, the center frequency corresponds to a frequency substantially midway between an upper bound and a lower bound of the communication frequency band. In some embodiments, the center frequency corresponds to a resonant frequency of an antenna element of the antenna apparatus at which the antenna element exhibits a minimum of a reflection coefficient at a radio frequency port of the antenna element, the resonant frequency falling within the communication frequency band.

As used herein, the phrase “at or near a center frequency of the communication frequency band” refers to a frequency within the communication frequency band that is within a tolerance range of the center frequency of the communication frequency band sufficient to satisfy a performance condition being described.

As used herein, “contiguous conductive structure” refers to a topologically continuous conductive structure formed by a plurality of parasitic elements that are electrically connected to one another through an interconnection conductor, the interconnection conductor including at least one high impedance circuit as an integral part thereof. The term “contiguous” refers to the topological continuity of the conductive structure, not to a uniform low impedance throughout all frequencies of operation. A direct-current conductive path exists from any one of the parasitic elements to any other one of the parasitic elements through the interconnection conductor, and the high impedance circuit includes conductive components that form part of this direct-current conductive path.

The contiguous conductive structure is coupled to a single proximity sensor port through a conductive coupling, such that the single proximity sensor port serves the plurality of parasitic elements regardless of the number of parasitic elements. Each parasitic element serves as a capacitive sensing electrode, and the interconnection conductor electrically couples the plurality of parasitic elements to one another to form a unified sensing electrode having a larger sensing area than an individual parasitic element. At the sensing frequency band, the high impedance circuit presents a low impedance so that the plurality of parasitic elements and the interconnection conductor operate as the unified sensing electrode; at the communication frequency band, the high impedance circuit presents a high impedance as defined above, blocking radio frequency current from propagating along the interconnection conductor between adjacent parasitic elements.

As used herein, “communication frequency band” refers to a radio frequency band at which the antenna elements operate for wireless communication. In some embodiments, the communication frequency band corresponds to a band within approximately 6 gigahertz to approximately 10 gigahertz. As used herein, “sensing frequency band” refers to a frequency band at which the proximity sensor port operates for capacitive proximity detection, and the sensing frequency band is lower than the communication frequency band. In some embodiments, the sensing frequency band is at or below approximately 1 megahertz (i.e., 1 MHz).

As used herein, “parasitic element” refers to a conductive element that is not directly fed by a radio frequency signal but is electromagnetically coupled to a corresponding antenna element. As used herein, “director element” refers to a parasitic element configured to increase a radiation gain of the corresponding antenna element by directing electromagnetic energy in a forward direction.

As used herein, “sensing electrode” refers to a conductive structure that, when coupled to a proximity sensor port at a sensing frequency band, exhibits a capacitance variable with a distance between the conductive structure and an approaching object, the capacitance being sensed at the proximity sensor port for proximity detection. In embodiments described herein, each parasitic element serves as a sensing electrode, and the plurality of parasitic elements coupled by the interconnection conductor collectively form a unified sensing electrode.

As used herein, “lumped circuit” refers to a circuit implemented using discrete reactive components. Examples of lumped circuit implementations of the high impedance circuit include a notch filter, a low pass filter, and other filter topologies as described herein. As used herein, “transmission line segment” refers to a segment of conductive trace having an electrical length configured to present a target impedance at a target frequency through impedance transformation along the conductive trace.

For brevity, “radio frequency” may be referred to as “RF,” “high impedance circuit” may be referred to as “HIC,” and “multiple-input multiple-output” may be referred to as “MIMO.” These abbreviations and their full forms are used interchangeably herein.

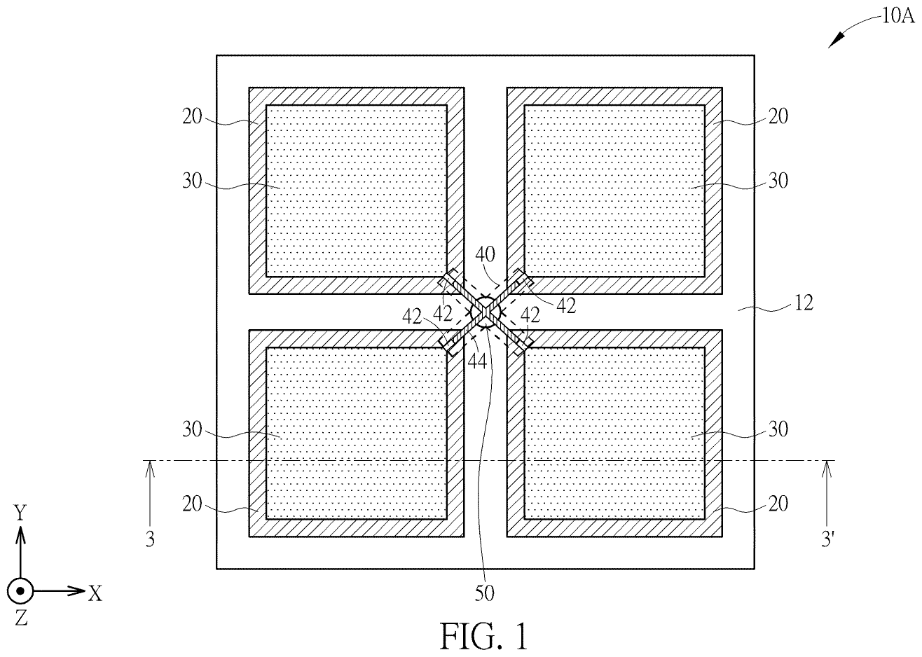

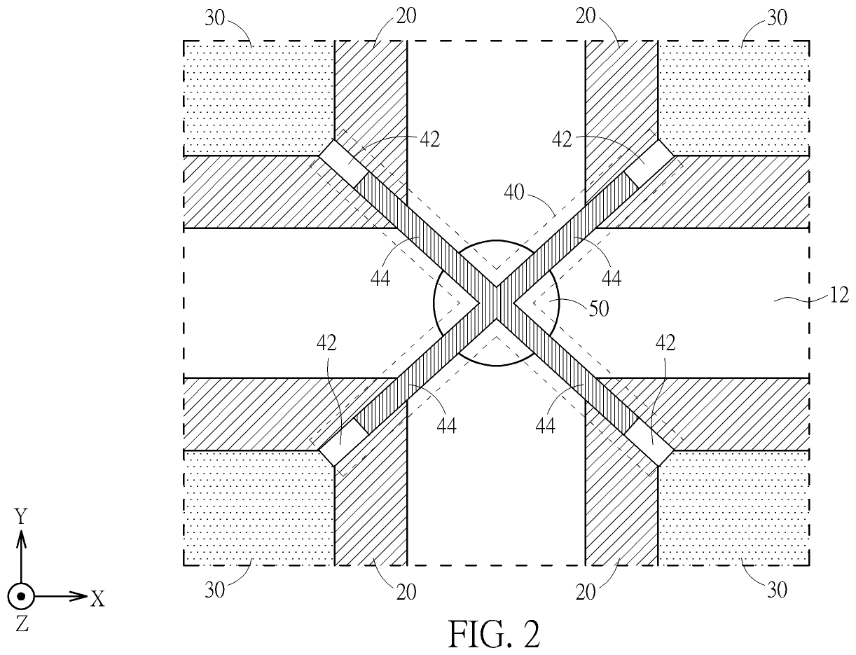

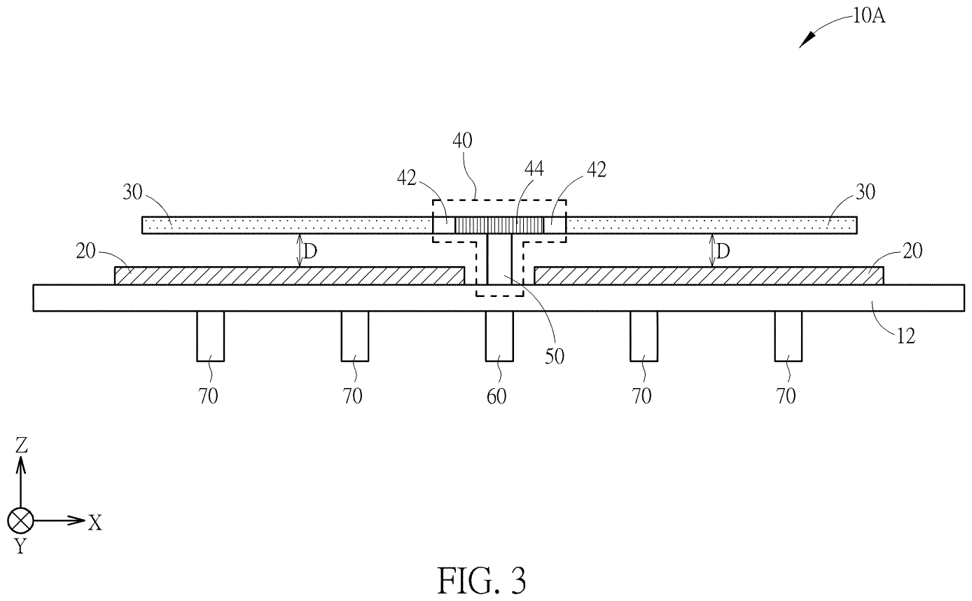

FIGS. 1, 2, and 3 illustrate an antenna apparatus 10A according to an embodiment of the present disclosure. FIG. 1 is a top plan view of the antenna apparatus 10A. FIG. 2 is an enlarged partial view of a portion of the antenna apparatus 10A of FIG. 1. FIG. 3 is a cross-sectional view of the antenna apparatus 10A of FIG. 1, taken along a section line 3-3′ shown in FIG. 1. A coordinate system having three axes X, Y, and Z is shown in FIGS. 1, 2, and 3 for reference. The axis X and the axis Y define a plane parallel to a major surface of a circuit board 12 of the antenna apparatus 10A, and the axis Z is perpendicular to the major surface of the circuit board 12. The same orientation of the axes X, Y, and Z is maintained across FIGS. 1, 2, and 3.

The antenna apparatus 10A comprises the circuit board 12, a plurality of antenna elements 20 disposed on the circuit board 12, a plurality of parasitic elements 30 disposed above the antenna elements 20, an interconnection conductor 40 coupling the plurality of parasitic elements 30 to one another, a conductor 50, and a proximity sensor port 60. Each antenna element 20 is configured to radiate a radio frequency signal at a communication frequency band, and each antenna element 20 is coupled to a respective radio frequency port 70 (shown in FIG. 3) through which the radio frequency signal is delivered to or received from the antenna element 20. As shown in the cross section of FIG. 3, the radio frequency ports 70 are disposed below a lower surface of the circuit board 12, and each radio frequency port 70 is electrically coupled to the respective antenna element 20 through a vertical probe extending through the circuit board 12.

In the embodiment shown in FIG. 1, the plurality of antenna elements 20 includes four antenna elements 20 arranged in a two-dimensional array in a two-by-two configuration along the axis X and the axis Y. The communication frequency band may correspond to any of several radio frequency bands, including a sub-6 gigahertz band within the first frequency range (FR1), a band within the third frequency range (FR3), or a millimeter-wave band within the second frequency range (FR2), as described further below. In the embodiment described with reference to FIG. 1, the communication frequency band corresponds to a band within approximately 6 gigahertz to approximately 10 gigahertz, which falls within FR3 and is targeted for next-generation wireless systems. The two-by-two arrangement of the antenna elements 20 supports multiple-input multiple-output (MIMO) operation at the communication frequency band.

While four antenna elements 20 in a two-by-two arrangement are illustrated in FIG. 1, the plurality of antenna elements 20 may include a different number of antenna elements 20 arranged in a different array configuration in other embodiments. In some embodiments, the plurality of antenna elements 20 is arranged in an n by m array configuration, where n denotes a number of antenna elements 20 disposed along a first direction parallel to the axis X, m denotes a number of antenna elements 20 disposed along a second direction parallel to the axis Y, n and m are positive integers, and at least one of n and m is greater than or equal to 2.

The n by m array configuration encompasses one-dimensional array configurations in which one of n and m is equal to 1, such as a 1 by 4 configuration or a 1 by 8 configuration, and two-dimensional array configurations in which both n and m are greater than or equal to 2, such as the 2 by 2 configuration shown in FIG. 1, a 3 by 3 configuration, or a 4 by 4 configuration. The plurality of parasitic elements 30 is arranged in one-to-one correspondence with the plurality of antenna elements 20, such that each parasitic element 30 is positioned in correspondence with a respective antenna element 20 at a respective position of the n by m array.

As shown in the cross section of FIG. 3, each parasitic element 30 is disposed above a respective antenna element 20 of the plurality of antenna elements 20 along the axis Z. The parasitic element 30 is parallel to the respective antenna element 20 and is separated from the respective antenna element 20 by a gap D. The gap D may be filled with a dielectric medium, such as air, a foam spacer, or a dielectric supporting structure on which the parasitic element 30 is disposed above the respective antenna element 20. The gap D provides direct-current isolation between the parasitic element 30 and the respective antenna element 20, and at the same time permits electromagnetic coupling between them at the communication frequency band. In addition, the gap D presents a high impedance to a low-frequency sensing signal at a sensing frequency band, inherently blocking the sensing signal from leaking to the radio frequency port 70. The combined effect of the gap D and the high impedance circuits 42 described below enables the antenna apparatus 10A to function simultaneously as a multiple-input multiple-output antenna array at the communication frequency band and as a proximity sensor at the sensing frequency band.

As shown in the top plan view of FIG. 1, each parasitic element 30 occupies an area in the X-Y plane that is positioned in correspondence with the respective antenna element 20. In some embodiments, each parasitic element 30 comprises a passive conductive patch generally rectangular or square in shape and having a planar surface oriented parallel to the X-Y plane. The parasitic element 30 is referred to as passive in that the parasitic element 30 is not directly fed by a radio frequency feed; instead, the parasitic element 30 receives radio frequency energy from the respective antenna element 20 through electromagnetic coupling across the gap D. In some embodiments, the parasitic element 30 is formed from a metal layer comprising copper, aluminum, or another conductive metal. The metal layer may be disposed on a dielectric supporting structure that positions the parasitic element 30 above the respective antenna element 20 by the gap D. In other embodiments, each parasitic element 30 has an alternative shape that provides the electromagnetic coupling to the respective antenna element 20. For example, each parasitic 30 element may comprise a frequency-selective surface (FSS) in place of a solid conductive patch. The frequency-selective surface is formed by a periodic array of conductive unit cells, such as conductive loops or conductive crosses, disposed on a supporting surface. A dimension of each unit cell, such as a diameter of a conductive loop or a length of a cross arm, is selected such that the frequency-selective surface is substantially reflective at the communication frequency band and electromagnetically couples to the respective antenna element 20 across the gap D in a manner comparable to a solid conductive patch.

Each parasitic element 30 is configured as a director element to increase a radiation gain of the respective antenna element 20. Through the electromagnetic coupling across the gap D, the parasitic element 30 directs a portion of the electromagnetic energy radiated by the antenna element 20 in a forward direction along the axis Z. The director function provided by the parasitic elements 30 increases the radiation gain of the antenna apparatus 10A as compared to a baseline antenna array having the antenna elements 20 alone.

The interconnection conductor 40 is shown in the top plan view of FIG. 1, in the enlarged partial view of FIG. 2, and in the cross-sectional view of FIG. 3. The interconnection conductor 40 includes a conductor 44 and a plurality of high impedance circuits 42. As enlarged in FIG. 2, the conductor 44 comprises a plurality of conductive branches extending along multiple directions in the X-Y plane and converging at a central region of the interconnection conductor 40, with each conductive branch terminating at a respective one of the high impedance circuits 42. Each high impedance circuit 42 is disposed between a respective parasitic element 30 and the corresponding conductive branch of the conductor 44, the high impedance circuit 42 being electrically coupled at one end to the respective parasitic element 30 and at another end to the corresponding conductive branch of the conductor 44. In the embodiment shown in FIGS. 1 and 2, the antenna apparatus 10A includes four high impedance circuits 42 corresponding to the four parasitic elements 30. As shown in the cross section of FIG. 3, the interconnection conductor 40 is disposed at the same vertical level as the parasitic elements 30 along the axis Z and extends laterally between the parasitic elements 30. The interconnection conductor 40, together with the parasitic elements 30, forms the contiguous conductive structure defined above.

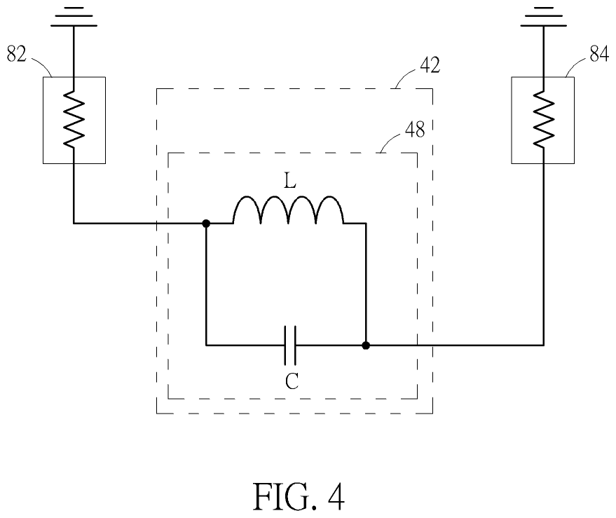

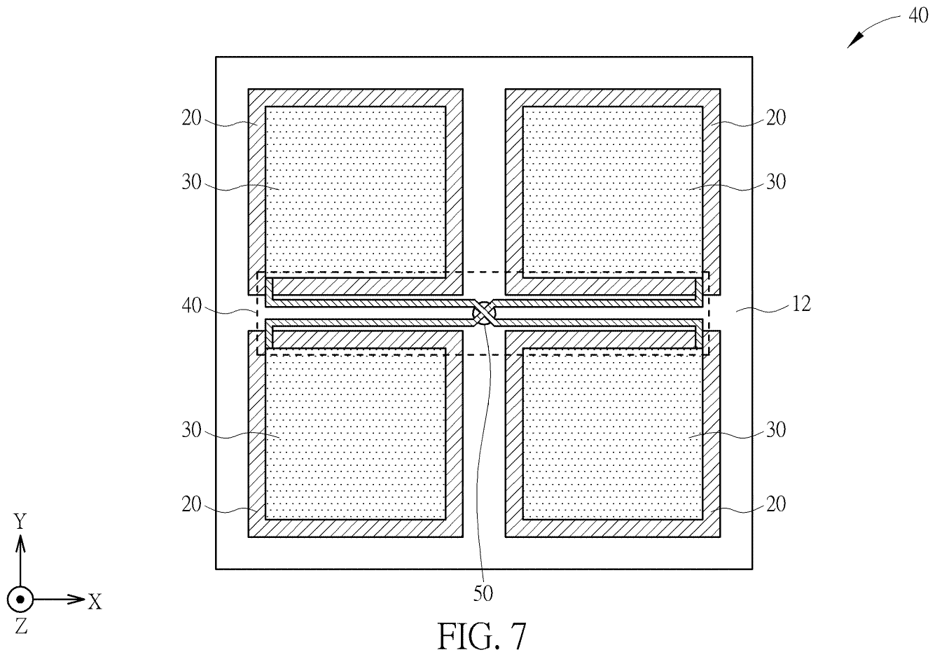

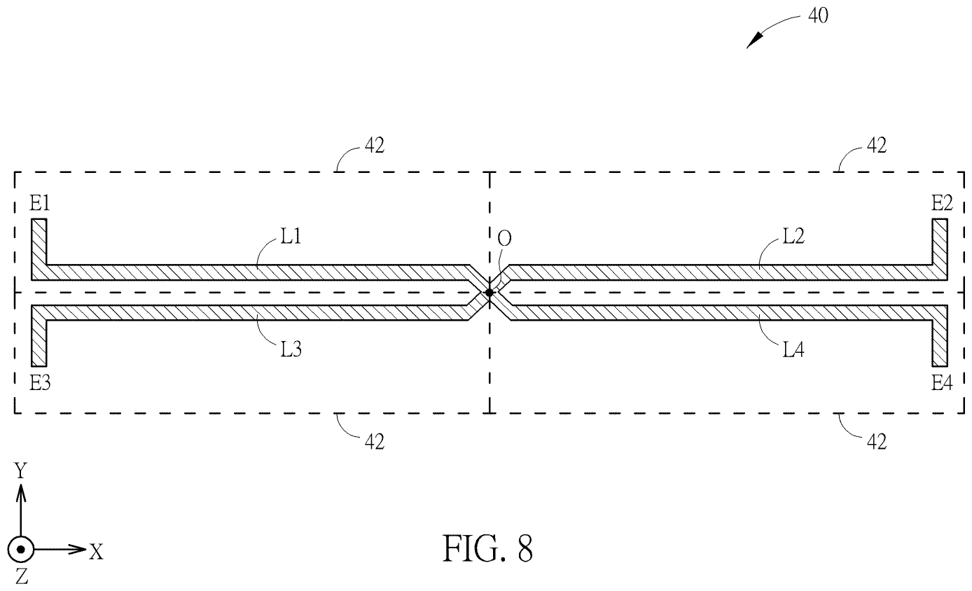

The high impedance circuit 42 is configured to present the high impedance at the communication frequency band and to present a low impedance at the sensing frequency band lower than the communication frequency band. In some embodiments, each high impedance circuit 42 of the antenna apparatus 10A is implemented as a lumped circuit comprising a parallel combination of an inductor and a capacitor, an embodiment described in further detail with reference to FIG. 4. In other embodiments, the at least one high impedance circuit 42 is implemented as a transmission line structure comprising one or more transmission line segments having electrical lengths configured to present an open-circuit impedance at the communication frequency band, an embodiment described in further detail with reference to FIGS. 7 and 8.

The conductor 50 is shown in the top plan view of FIG. 1 and in the enlarged partial view of FIG. 2 at an intersection region of the interconnection conductor 40 where the conductive branches of the conductor 44 converge, and is shown in the cross section of FIG. 3 extending along the axis Z from the interconnection conductor 40 to the proximity sensor port 60. The conductor 50 comprises a via conductor passing through the circuit board 12 from the interconnection conductor 40 to the proximity sensor port 60 disposed below a lower surface of the circuit board 12. The proximity sensor port 60 is a single proximity sensor port coupled to each of the plurality of parasitic elements 30 through the interconnection conductor 40 and the conductor 50, such that one proximity sensor port 60 serves the entire array of parasitic elements 30 of the antenna apparatus 10A regardless of the number of antenna elements 20 in the array. The section line 3-3′ shown in FIG. 1 extends through one of the antenna elements 20, the corresponding parasitic element 30 disposed above the antenna element 20, and the conductor 50.

The proximity sensor port 60 is configured to be coupled to a capacitive proximity sensing circuit operating at the sensing frequency band lower than the communication frequency band. The capacitive proximity sensing circuit may comprise an integrated circuit configured to measure a capacitance between the contiguous conductive structure and a reference potential, and to provide a proximity detection output based on a change in the measured capacitance caused by an object approaching the antenna apparatus 10A. The capacitive proximity sensing circuit may be coupled to the proximity sensor port 60 through a wire trace, a flexible cable, or another conductive coupling element.

Based on the frequency-selective impedance characteristic of the high impedance circuits 42, the parasitic elements 30 perform two functions concurrently. At the sensing frequency band, the high impedance circuits 42 present the low impedance, and each parasitic element 30 functions as a capacitive sensing electrode. The parasitic elements 30, electrically coupled through the interconnection conductor 40, collectively form a unified sensing electrode coupled to the proximity sensor port 60 through the conductor 50. The unified sensing electrode provides a larger effective sensing area than a single parasitic element 30 alone, increasing the capacitive coupling between the unified sensing electrode and an approaching object. At the communication frequency band, the high impedance circuits 42 present the high impedance, blocking radio frequency current from propagating along the interconnection conductor 40 between adjacent parasitic elements 30 and blocking radio frequency energy from leaking through the interconnection conductor 40 and the conductor 50 to the proximity sensor port 60. As a result, an isolation between each antenna element 20 of the plurality of antenna elements 20 and the proximity sensor port 60 is less than approximately −15 decibels across the communication frequency band, where the isolation is measured as the magnitude of the scattering parameter S21 from the radio frequency port 70 of each antenna element 20 to the proximity sensor port 60.

The configuration of the antenna apparatus 10A shown in FIGS. 1, 2, and 3 provides a measurable improvement in radiation gain as compared to an antenna array having the antenna elements 20 alone. In a baseline configuration without the parasitic elements 30, the antenna array exhibits a radiation gain of approximately 5.35 dBi at the communication frequency band, where dBi is a unit of antenna gain expressed in decibels relative to a reference gain of an isotropic radiator. With the parasitic elements 30 disposed above the antenna elements 20 but not interconnected, the radiation gain increases to approximately 5.84 dBi. When the parasitic elements 30 are interconnected by an interconnection conductor without high impedance circuits 42, the radiation gain decreases to approximately 4.62 dBi due to poor isolation between each radio frequency port 70 and the proximity sensor port 60 caused by radio frequency current propagating along the interconnection conductor between adjacent parasitic elements 30. With the high impedance circuits 42 disposed in the interconnection conductor 40 as in the antenna apparatus 10A, in which the high impedance circuits 42 are implemented as lumped circuits, the radiation gain is restored to approximately 6.08 dBi. The configuration of the parasitic elements 30 interconnected by the interconnection conductor 40 with the high impedance circuits 42 thus provides a unified sensing electrode coupled to a single proximity sensor port 60 while achieving a radiation gain greater than the baseline gain of the antenna array without the parasitic elements 30.

FIG. 4 is a circuit schematic illustrating an equivalent circuit representation of the high impedance circuit 42 of the antenna apparatus 10A of FIG. 1 in an embodiment in which the high impedance circuit 42 is implemented as a lumped circuit 48. The circuit schematic of FIG. 4 shows the lumped circuit 48 disposed electrically between a first terminating resistor 82 and a second terminating resistor 84. The first terminating resistor 82 represents an equivalent impedance as seen from a first terminal of the lumped circuit 48 looking toward a respective parasitic element 30 of FIG. 1, and the second terminating resistor 84 represents an equivalent impedance as seen from a second terminal of the lumped circuit 48 looking toward a conductive branch of the conductor 44 of the interconnection conductor 40. Each of the first terminating resistor 82 and the second terminating resistor 84 has a resistance value equal to a reference characteristic impedance, approximately 50 ohms in some embodiments. The first terminating resistor 82 and the second terminating resistor 84 are shown in FIG. 4 to illustrate measurement conditions of the lumped circuit 48 for scattering parameter analysis at the two terminals of the lumped circuit 48, rather than as separate physical components of the antenna apparatus 10A.

The lumped circuit 48 is implemented as a notch filter, also referred to as a band-reject filter, and comprises a parallel combination of an inductor L and a capacitor C. The symbols L and C are used herein to denote either the components themselves or, in numerical expressions, the inductance and capacitance values thereof respectively. The inductor L and the capacitor C comprise discrete reactive components connected in parallel between a first terminal and a second terminal of the lumped circuit 48. The first terminal is electrically connected to the respective parasitic element 30, and the second terminal is electrically connected to the conductive branch of the conductor 44 of the interconnection conductor 40.

The parallel combination of the inductor L and the capacitor C has a resonant frequency fᵣ within the communication frequency band, where the symbol fr denotes the frequency at which the parallel combination presents a maximum impedance. The resonant frequency fᵣ is given by

$${f}_{r} = \frac{1}{2 π \sqrt{L C}}$$

where Lis the inductance of the inductor L and C is the capacitance of the capacitor C. The maximum impedance presented by the parallel combination at the resonant frequency fᵣ corresponds to the high impedance condition presented by the high impedance circuit 42 at the communication frequency band.

In a particular embodiment, the antenna apparatus 10A is configured to operate at a target frequency of approximately 7 gigahertz, the inductance value of the inductor L is approximately 0.95 nanohenry (nH), and the capacitance value of the capacitor C is approximately 0.5 picofarad (pF). Substitution of these component values into the resonant frequency formula a yields a resonant frequency fr of approximately 7.3 gigahertz, which falls within the communication frequency band of approximately 6 gigahertz to approximately 10 gigahertz. In other embodiments, the inductance value of the inductor L is in a range of approximately 0.3 nH to approximately 2 nH, and the capacitance value of the capacitor C is in a range of approximately 0.1 pF to approximately 2 pF, with specific component values selected to place the resonant frequency fr at a target frequency within the communication frequency band.

At frequencies substantially below the resonant frequency fᵣ, the impedance of the parallel combination of the inductor L and the capacitor C is dominated by the inductive reactance of the inductor L, which is relatively low at low frequencies. At the sensing frequency band, which in some embodiments is at or below approximately 1 MHz, the inductive reactance of the inductor L at a frequency of approximately 1 MHz is computed as

j×2π×(1×10⁶)×(0.95×10⁻⁹)=j×0.006Ω

The magnitude of this inductive reactance is much smaller than a reference characteristic impedance of approximately 50 ohms, confirming that the lumped circuit 48 presents the low impedance at the sensing frequency band and allows a capacitive sensing signal to propagate along the interconnection conductor 40 with low loss.

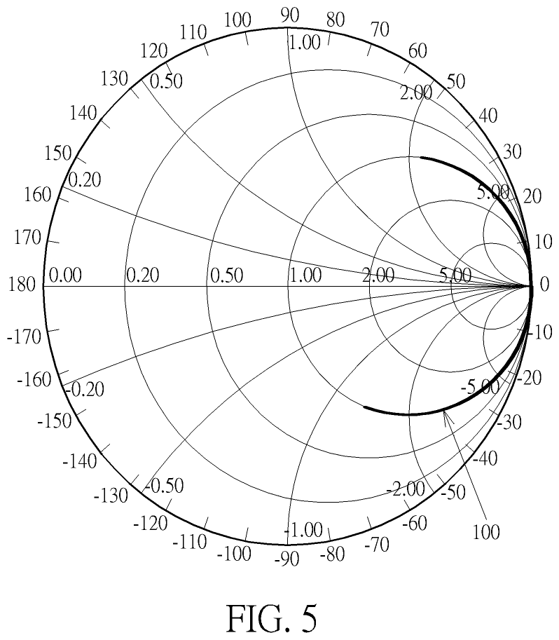

FIG. 5 is a Smith chart illustrating a curve 100 representing an impedance locus of the antenna apparatus 10A of FIG. 1 over a frequency range encompassing the communication frequency band, the impedance locus being observed across the high impedance circuit 42 along the interconnection conductor 40. The Smith chart of FIG. 5 is a standard Smith chart normalized to a reference characteristic impedance of approximately 50 ohms, with a center point of the Smith chart corresponding to a normalized impedance of 1.0 (that is, an impedance matched to the reference characteristic impedance), a leftmost vertex of the Smith chart corresponding to a normalized impedance of 0 (that is, a short-circuit point), and a rightmost vertex of the Smith chart corresponding to a normalized impedance of infinity (that is, an open-circuit point). The upper half of the Smith chart corresponds to inductive impedance with a positive reactance, and the lower half of the Smith chart corresponds to capacitive impedance with a negative reactance.

The curve 100 traces the impedance of the antenna apparatus 10A observed across the high impedance circuit 42 as a function of frequency. Over the frequency range of the communication frequency band, the curve 100 is concentrated in a region of the Smith chart proximate to the rightmost vertex of the Smith chart, that is, proximate to the open-circuit region. The location of the curve 100 near an outer boundary of the Smith chart indicates that a reflection coefficient observed across the high impedance circuit 42 has a magnitude close to 1, such that radio frequency current incident on the high impedance circuit 42 from the interconnection conductor 40 is substantially reflected. The resulting reflection coefficient corresponds to an impedance in which a reactance component is substantially larger than a resistance component, consistent with the high impedance condition described above.

The concentration of the curve 100 in the open-circuit region of the Smith chart at or near the center frequency of the communication frequency band confirms that the high impedance circuit 42 within the antenna apparatus 10A satisfies the high impedance condition defined as above. The open-circuit characterization corresponds to a physical condition in which the high impedance circuit 42 substantially blocks radio frequency current from propagating along the interconnection conductor 40 through the high impedance circuit 42 at or near the center frequency of the communication frequency band.

At the sensing frequency band, the impedance of the antenna apparatus 10A observed across the high impedance circuit 42 migrates away from the open-circuit region of the Smith chart toward a region of lower impedance magnitude. In some embodiments, the impedance observed across the high impedance circuit 42 at the sensing frequency band is less than approximately 50 ohms, corresponding to a region of the Smith chart near the center point of the Smith chart.

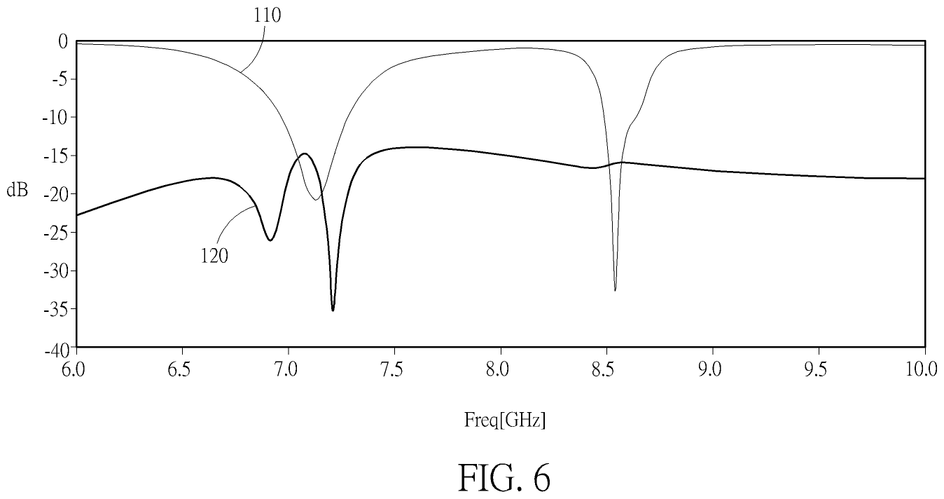

FIG. 6 is a graph illustrating a curve 110 representing a return loss and a curve 120 representing an isolation of the antenna apparatus 10A of FIG. 1 as functions of frequency. The horizontal axis of the graph of FIG. 6 represents frequency, with a frequency range spanning at least the communication frequency band of approximately 6 gigahertz to approximately 10 gigahertz. The vertical axis of the graph of FIG. 6 represents a scattering parameter magnitude in decibels, with values ranging from a higher value (for example, 0 decibels, corresponding to total reflection or no isolation) at the upper end of the vertical axis to a lower value (for example, −30 decibels or lower, corresponding to strong matching or strong isolation) at the lower end of the vertical axis.

The curve 110 represents a magnitude of a scattering parameter Si at a radio frequency port 70 of one of the antenna elements 20 of the antenna apparatus 10A, where the scattering parameter S11 denotes a reflection coefficient at the radio frequency port 70 of the antenna element 20, plotted as a function of frequency across the horizontal axis. The curve 110 indicates a degree of impedance matching of the antenna element 20 to the radio frequency port 70 over the frequency range of the communication frequency band. Across the communication frequency band, the curve 110 exhibits a magnitude that indicates the antenna element 20 is impedance matched at the radio frequency port 70, supporting radio frequency signal transmission and reception at each antenna element 20 across the communication frequency band. In a particular embodiment of the antenna apparatus 10A corresponding to the inductance and capacitance values of approximately 0.95 nH and approximately 0.5 pF described above with reference to FIG. 4, the curve 110 has a magnitude of approximately −18.98 decibels at a frequency of approximately 7.1 gigahertz, the frequency of approximately 7.1 gigahertz being a frequency at which the magnitude of the scattering parameter S11 represented by the curve 110 is minimized.

The curve 120 represents a magnitude of a scattering parameter S21 from the radio frequency port 70 of one of the antenna elements 20 to the proximity sensor port 60 of the antenna apparatus 10A, plotted as a function of frequency across the horizontal axis. Across the communication frequency band of approximately 6 gigahertz to approximately 10 gigahertz, the curve 120 has a magnitude of less than approximately −15 decibels, confirming that the high impedance circuit 42 effectively blocks radio frequency energy from propagating along the interconnection conductor 40 to the proximity sensor port 60 across the communication frequency band. In a particular embodiment, the curve 120 has a magnitude of approximately −15.12 decibels at a frequency of approximately 7.1 gigahertz, satisfying the high impedance condition characterized by the third measure described above.

FIG. 6 illustrates the curve 110 and the curve 120 with reference to a single antenna element 20 of the plurality of antenna elements 20 of the antenna apparatus 10A. For each antenna element 20 of the plurality of antenna elements 20, a scattering parameter S11 at the radio frequency port 70 of the antenna element 20 exhibits a shape substantially similar to the curve 110 of FIG. 6, and a scattering parameter S21 between the radio frequency port 70 of the antenna element 20 and the proximity sensor port 60 exhibits a shape substantially similar to the curve 120 of FIG. 6. The isolation between each antenna element 20 of the plurality of antenna elements 20 and the proximity sensor port 60 is accordingly less than approximately −15 decibels across the communication frequency band.

FIGS. 7 and 8 illustrate an antenna apparatus 10B according to another embodiment of the present disclosure. FIG. 7 is a top plan view of the antenna apparatus 10B. FIG. 8 is a detail view illustrating a high impedance circuit 42 of the antenna apparatus 10B at a central region of an interconnection conductor 40 thereof. The same coordinate system having three axes X, Y, and Z described above is shown in FIGS. 7 and 8 with the same orientation as in FIGS. 1, 2, and 3. The antenna apparatus 10B has the same structural organization of a circuit board 12, a plurality of antenna elements 20, a plurality of parasitic elements 30, an interconnection conductor 40, a conductor 50, and a proximity sensor port (corresponding to the proximity sensor port 60 described above) as the antenna apparatus 10A of FIGS. 1, 2, and 3. As shown in the top plan view of FIG. 7, the plurality of antenna elements 20 includes four antenna elements 20 arranged in a two-by-two configuration along the axis X and the axis Y, and the plurality of parasitic elements 30 includes four parasitic elements 30 arranged in correspondence with the four antenna elements 20. The antenna apparatus 10B may alternatively include a plurality of antenna elements 20 arranged in an n by m array configuration as described above with reference to FIGS. 1, 2, and 3.

The antenna apparatus 10B differs from the antenna apparatus 10A in the implementation of the high impedance circuit 42 disposed in the interconnection conductor 40. In the antenna apparatus 10A, the high impedance circuit 42 is implemented as the lumped circuit 48 comprising the parallel combination of the inductor L and the capacitor C as described with reference to FIG. 4. In the antenna apparatus 10B, the high impedance circuit 42 is implemented as a transmission line structure comprising a plurality of transmission line segments, as illustrated in further detail in FIG. 8.

As shown in FIG. 8, the high impedance circuit 42 of the antenna apparatus 10B comprises a plurality of transmission line segments, illustrated as a first transmission line segment L1, a second transmission line segment L2, a third transmission line segment L3, and a fourth transmission line segment L4. Each of the transmission line segments is a segment of conductive trace disposed at the same vertical level as the parasitic elements 30 and having an electrical length configured to present an open-circuit impedance at the communication frequency band. Each transmission line segment has a respective first end coupled to a respective parasitic element 30 of the plurality of parasitic elements 30 and a respective second end opposite to the respective first end, the respective second ends being joined to one another at a common connection point O.

The respective first ends of the transmission line segments L1, L2, L3, and L4 are denoted as ends E1, E2, E3, and E4, respectively. Each of the ends E1, E2, E3, and E4 is coupled to a respective one of the parasitic elements 30 of the antenna apparatus 10B at a respective conductive position thereon. In the embodiment shown in FIG. 8, each of the ends E1, E2, E3, and E4 is coupled to a corner of a respective one of the four parasitic elements 30.

The respective second ends of the transmission line segments L1, L2, L3, and L4, that is, the ends opposite to the ends E1, E2, E3, and E4, are electrically connected to one another at the common connection point O. The connection point O is a single node of the high impedance circuit 42 at which the respective second ends of the four transmission line segments meet. The conductor 50 of the antenna apparatus 10B is coupled to the connection point O and extends from the connection point O through the circuit board 12 to the proximity sensor port disposed below a lower surface of the circuit board 12. The conductor 50 thus provides a single conductive coupling from the four parasitic elements 30, through the four transmission line segments converging at the connection point O, to the proximity sensor port.

While FIG. 8 illustrates the four transmission line segments extending radially outward from the connection point O in four different directions in the X-Y plane, in other embodiments, each transmission line segment may have a curved shape, a meandered shape, an L-shape, a bent shape, or any other shape, provided that the electrical length of the transmission line segment is configured to satisfy the open-circuit impedance condition at the communication frequency band as described herein. Likewise, the respective ends E1, E2, E3, and E4 may be coupled to the corresponding parasitic elements 30 at any conductive position thereof, and are not limited to being coupled at the corners of the respective parasitic elements 30. For example, the end E1, E2, E3, or E4 may be coupled to a corner, an edge, or an interior position of the corresponding parasitic element 30. Coupling each of the ends E1, E2, E3, and E4 to a different position on the respective parasitic element 30 changes the impedance seen looking into the corresponding end of the transmission line segment from the parasitic element 30, and an electrical length of the corresponding transmission line segment may be selected to transform the impedance seen at the corresponding end into the open-circuit impedance at the communication frequency band, as further described below. Accordingly, the high impedance circuit 42 of the antenna apparatus 10B comprises any conductive path arrangement of the transmission line segments that achieves the open-circuit impedance condition at the communication frequency band.

Each transmission line segment may be formed from a printed conductive trace disposed at the same vertical level as the parasitic elements 30. The printed conductive trace of each transmission line segment may be fabricated by a conductive layer patterning process without requiring discrete reactive components. The printed conductive trace of each transmission line segment has a width, a length, and a characteristic impedance, the characteristic impedance being determined by the width of the printed conductive trace, a vertical distance between the printed conductive trace and a reference ground plane of the antenna apparatus 10B, and a relative permittivity of a dielectric medium between the printed conductive trace and the reference ground plane. In some embodiments, the reference ground plane is disposed on or within the circuit board 12. In some embodiments, the characteristic impedance of each transmission line segment is in a range of approximately 50 ohms to approximately 100 ohms.

In some embodiments, each of the transmission line segments L1, L2, L3, and L4 has an electrical length of approximately λ/2, where λ denotes a wavelength at a center frequency of the communication frequency band. The respective second ends of the transmission line segments are joined at the connection point O, and the connection point O is coupled to the proximity sensor port through the conductor 50 extending through the circuit board 12. At the center frequency of the communication frequency band, the proximity sensor port presents a high impedance toward the connection point O. Accordingly, the approximately λ/2 electrical length of each transmission line segment transforms the high impedance at the proximity sensor port to an open-circuit impedance at each of the ends E1, E2, E3, and E4 at the center frequency of the communication frequency band.

In some embodiments, the transmission line segments L1, L2, L3, and L4 have electrical lengths that differ from one another, such that the impedance presented at each of the ends E1, E2, E3, and E4 is tuned independently of the other ends, for example to compensate for different coupling positions of the respective ends E1, E2, E3, and E4 on the corresponding parasitic elements 30 as described above.

At the sensing frequency band, the impedance transformation through the electrical length of each transmission line segment approaches zero, because the physical lengths of the transmission line segments correspond to very small electrical lengths at the sensing frequency band. The transmission line segments therefore collectively appear as a short circuit at the sensing frequency band, and the four parasitic elements 30, electrically coupled through the interconnection conductor 40, collectively form the unified sensing electrode coupled to the proximity sensor port through the conductor 50, as described with reference to the antenna apparatus 10A.

In a particular embodiment, the antenna apparatus 10B is configured to operate at a target frequency of approximately 7 gigahertz and exhibits a radiation gain of approximately 6.43 dBi at the target frequency. This radiation gain is higher than the radiation gain of approximately 6.08 dBi exhibited by the antenna apparatus 10A of FIG. 1 at the same target frequency. The improvement in radiation gain of the antenna apparatus 10B over the antenna apparatus 10A is attributable at least in part to a lower insertion loss of the transmission line segments L1, L2, L3, and L4 of the antenna apparatus 10B at the communication frequency band, as compared to an insertion loss of the lumped circuit 48 of the antenna apparatus 10A at the communication frequency band.

In a particular embodiment, an isolation between each antenna element 20 of the plurality of antenna elements 20 of the antenna apparatus 10B and the proximity sensor port 60 is less than approximately −15 decibels across the communication frequency band of approximately 6 gigahertz to approximately 10 gigahertz, where the isolation is measured as the magnitude of a scattering parameter S21 from the radio frequency port 70 of each antenna element 20 of the antenna apparatus 10B to the proximity sensor port 60. The isolation provided by the antenna apparatus 10B across the communication frequency band corresponds to the high impedance condition characterized by the third measure described above with reference to the antenna apparatus 10A.

Although four transmission line segments L1, L2, L3, and L4 joined at the common connection point O are illustrated in FIG. 8 corresponding to the four parasitic elements 30 of the antenna apparatus 10B shown in FIG. 7, the high impedance circuit 42 of the antenna apparatus 10B may include a different number of transmission line segments arranged in a different geometric arrangement to correspond to the n by m array configuration of the plurality of parasitic elements 30. In an embodiment in which the plurality of parasitic elements 30 includes a number P of parasitic elements 30, the high impedance circuit 42 of the antenna apparatus 10B may include a corresponding number P of transmission line segments coupled to the P parasitic elements 30 respectively at first ends of the transmission line segments and joined together at the common connection point O at second ends of the transmission line segments. The specific number, geometric arrangement, individual shape, and connection positions on the parasitic elements 30 of the transmission line segments may be selected based on the array configuration of the plurality of parasitic elements 30 and the routing constraints of the circuit board 12.

The embodiments described above with reference to FIG. 1 through FIG. 8 illustrate particular implementations of the antenna apparatus 10A and the antenna apparatus 10B. Further embodiments and variations, some of which are described in this section with reference to the elements introduced in FIG. 1 through FIG. 8, are within the scope of the present disclosure.

In the antenna apparatus 10A of FIG. 1, the high impedance circuit 42 is implemented as the lumped circuit 48 comprising the parallel combination of the inductor L and the capacitor C as shown in FIG. 4. In other embodiments, the high impedance circuit 42 is implemented as an alternative lumped circuit topology that presents a high impedance at the communication frequency band, such as a low pass filter having a cutoff frequency below the communication frequency band. The low pass filter is configured to attenuate signals at the communication frequency band higher than the cutoff frequency and to pass signals at the sensing frequency band lower than the cutoff frequency. The specific alternative lumped circuit topology is selected to achieve a target frequency response of the high impedance circuit 42 at the communication frequency band and at the sensing frequency band.

In the antenna apparatus 10B of FIG. 7, the high impedance circuit 42 is implemented as the plurality of transmission line segments L1, L2, L3, and L4 extending radially from the common connection point O as shown in FIG. 8. In other embodiments, the high impedance circuit 42 of the antenna apparatus 10B is implemented as an alternative transmission line structure.

In some embodiments, the antenna apparatus includes a plurality of high impedance circuits 42, a first subset of which comprises a lumped circuit 48 as described with reference to FIG. 4, and a second subset of which comprises transmission line segments as described with reference to FIG. 8. The mixed arrangement of lumped and transmission line implementations of the high impedance circuit 42 within a single antenna apparatus enables independent tuning of different signal paths between different pairs of the parasitic elements 30, and permits the use of the implementation that is better suited to the available board area at each position of the interconnection conductor 40.

In the embodiments described with reference to FIG. 1 through FIG. 8, each antenna element 20 may be implemented as a patch antenna, and the radio frequency port 70 of the antenna element 20 may be a coaxial probe port extending through the circuit board 12 to couple to the antenna element 20.

In the embodiments described above with reference to FIG. 3, the gap D is illustrated as uniform across the plurality of antenna elements 20 and the plurality of parasitic elements 30. That is, each parasitic element 30 is illustrated as disposed above the respective antenna element 20 at a substantially equal gap D along the axis Z. In other embodiments, the gap D differs among different pairs of an antenna element 20 and the respective parasitic element 30 of the antenna apparatus.

A first gap D between a first antenna element 20 and a first parasitic element 30 of the antenna apparatus may differ from a second gap D between a second antenna element 20 and a second parasitic element 30 of the antenna apparatus. The non-uniform gap D arrangement provides different degrees of electromagnetic coupling at the respective pairs of the antenna element 20 and the parasitic element 30, supporting independent tuning of the radiation gain and the operating bandwidth of each antenna element 20 of the plurality of antenna elements 20.

In some embodiments, a first subset of the plurality of parasitic elements 30 is disposed at a first gap D above the respective antenna elements 20, and a second subset of the plurality of parasitic elements 30 is disposed at a second gap D above the respective antenna elements 20, the first gap D differing from the second gap D. The subset-based non-uniform gap D arrangement supports multi-band operation of the antenna apparatus. The first subset of the antenna elements 20 may operate at a first communication frequency band and use the first gap D selected for the first communication frequency band, while the second subset of the antenna elements 20 may operate at a second communication frequency band different from the first communication frequency band and use the second gap D selected for the second communication frequency band. The specific values of the respective gaps D may be selected to achieve target values of radiation gain, operating bandwidth, and electromagnetic coupling at the respective communication frequency bands.

In some embodiments, the antenna apparatus includes a plurality of layers of parasitic elements 30 disposed at different heights along the axis Z above the antenna elements 20. Each layer of parasitic elements 30 may include a respective interconnection conductor 40 and respective high impedance circuits 42, and each layer of parasitic elements 30 may be coupled to a respective proximity sensor port 60 through a respective conductor 50, the respective proximity sensor port 60 being disposed below a lower surface of the circuit board 12. The plurality of layers of parasitic elements 30 may be configured to provide radiation gain enhancement and proximity sensing capability at a respective communication frequency band for each layer, supporting multi-band operation of the antenna apparatus.

While the communication frequency band of the antenna apparatus 10A and the antenna apparatus 10B is described above as a band within approximately 6 gigahertz to approximately 10 gigahertz, corresponding to the third frequency range (FR3), the antenna apparatus 10A and the antenna apparatus 10B may be configured to operate at other communication frequency bands in other embodiments. In some embodiments, the communication frequency band is a sub-6 gigahertz band within the first frequency range (FR1), such as a band within approximately 0.41 gigahertz to approximately 7.125 gigahertz. In some e embodiments, the communication frequency band isa millimeter-wave band within the second frequency range (FR2), such as a band within approximately 24 gigahertz to approximately 52 gigahertz, or within approximately 52 gigahertz to approximately 71 gigahertz. For operation at an alternative communication frequency band, dimensions of the antenna elements 20, the parasitic elements 30, the gap D, the inductor L, the capacitor C, and the transmission line segments scale approximately with a wavelength at a center frequency of the alternative communication frequency band, such that the ratios of the physical dimensions to a wavelength at a center frequency of the communication frequency band are similar across embodiments operating at different communication frequency bands.

In some embodiments, the capacitive proximity sensing circuit described above with reference to FIG. 3 comprises a capacitance-to-digital converter integrated circuit, an analog front-end circuit configured to drive the contiguous conductive structure with a sensing signal at the sensing frequency band and to sense a return signal from the contiguous conductive structure, or a combination thereof. The capacitive proximity sensing circuit may be configured to detect an approach of a human body part toward the antenna apparatus 10A or the antenna apparatus 10B, and to provide a proximity detection output to a processor or a radio frequency controller coupled to the radio frequency ports 70 of the antenna elements 20. In some embodiments, the processor or the radio frequency controller is configured to reduce a transmit power at one or more of the radio frequency ports 70 in response to the proximity detection output indicating that the human body part is within a threshold distance of the antenna apparatus, thereby supporting regulatory compliance with electromagnetic exposure limits.

In contrast to the conventional approaches identified above, the antenna apparatus described herein uses the plurality of parasitic elements 30 concurrently as director elements at the communication frequency band and as a unified sensing electrode coupled to a single proximity sensor port 60 at the sensing frequency band, an arrangement enabled by the frequency-selective impedance characteristic of the at least one high impedance circuit 42 and applicable to both the lumped implementation and the transmission line implementation described above.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An antenna apparatus comprising:
a plurality of antenna elements, each configured to radiate at a communication frequency band;
a plurality of parasitic elements, each disposed adjacent to a respective antenna element of the plurality of antenna elements and electromagnetically coupled thereto, each parasitic element being physically separated from the respective antenna element;
an interconnection conductor coupled to the plurality of parasitic elements to form a contiguous conductive structure, the interconnection conductor comprising at least one high impedance circuit, the at least one high impedance circuit comprising a lumped circuit or a transmission line segment configured to present a high impedance at the communication frequency band; and
a proximity sensor port coupled to the contiguous conductive structure.

2. The antenna apparatus of claim 1, wherein the lumped circuit comprises a parallel combination of an inductor and a capacitor.

3. The antenna apparatus of claim 2, wherein the parallel combination of the inductor and the capacitor has a resonant frequency within the communication frequency band.

4. The antenna apparatus of claim 2, wherein the plurality of antenna elements comprises at least four antenna elements arranged in a two-dimensional array, each parasitic element being disposed above a respective antenna element of the at least four antenna elements, the interconnection conductor comprises conductive traces coupling adjacent ones of the plurality of parasitic elements, and the proximity sensor port is a single port coupled to the contiguous conductive structure.

5. The antenna apparatus of claim 4, wherein each parasitic element comprises a conductive patch disposed above the respective antenna element.

6. The antenna apparatus of claim 1, wherein the transmission line segment has an electrical length configured to present an open-circuit impedance at the communication frequency band.

7. The antenna apparatus of claim 6, wherein the transmission line segment is formed from printed conductive traces on a substrate.

8. The antenna apparatus of claim 1, wherein each parasitic element comprises a conductive patch disposed in a plane parallel to and spaced apart from the respective antenna element.

9. The antenna apparatus of claim 1, wherein each parasitic element is configured as a director element to increase a radiation gain of the respective antenna element.

10. The antenna apparatus of claim 1, wherein the plurality of antenna elements comprises at least four antenna elements arranged in an array.

11. The antenna apparatus of claim 10, wherein the at least one high impedance circuit comprises a plurality of high impedance circuits, each of the plurality of high impedance circuits being coupled between a respective parasitic element of the plurality of parasitic elements and the interconnection conductor.

12. The antenna apparatus of claim 1, wherein the proximity sensor port is a single proximity sensor port coupled to each of the plurality of parasitic elements through the interconnection conductor.

13. The antenna apparatus of claim 1, wherein the proximity sensor port is configured to be coupled to a capacitive proximity sensing circuit operating at a sensing frequency band lower than the communication frequency band.

14. The antenna apparatus of claim 13, wherein the sensing frequency band is at or below 1 MHz.

15. The antenna apparatus of claim 1, wherein the proximity sensor port is coupled to the contiguous conductive structure at an intersection of the interconnection conductor through a via conductor.

16. The antenna apparatus of claim 1, wherein the communication frequency band is from 6 GHz to 10 GHZ.

17. The antenna apparatus of claim 1, wherein an impedance presented by the at least one high impedance circuit at a sensing frequency band is less than the high impedance at the communication frequency band, and the sensing frequency band is below the communication frequency band.

18. The antenna apparatus of claim 1, wherein an isolation between each antenna element of the plurality of antenna elements and the proximity sensor port is less than −15 dB across the communication frequency band.
